(19) United States
(12) Patent Application Publication
(10) Pub. No.: US 2014/0164204 A1
(43) Pub. Date: Jun. 12, 2014

(54) Process for utilizing renewable electricity

(71) Applicant: Padraig McAlister, Dublin (IE)

(72) Inventor: Padraig McAlister, Dublin (IE)

(21) Appl. No.: 13/712,756

(22) Filed: Dec. 12, 2012

(51) Int. Cl. G06Q 40/04

(52) U.S. Cl. CPC G06Q 40/04
USPC 705/37

(57) ABSTRACT

This invention relates to a process for utilizing renewable electricity in a way which defines an absolute currency, facilitates investment in further renewable electricity generation & also is useful in protecting investors from the effects of inflation.

According to the invention a certified amount of renewable electricity delivered at a defined voltage & accessible grid point is utilized as a fully fungible alternative to a capital amount, or interest on capital, or both or a bond or security in a currency, thereby defining that capital or interest or security in absolute terms.

Such a process utilizing renewable electricity could be used as a means to raise capital which could in turn be used to develop further renewable electricity resources. The work on Energy Supply Models linked to Econometric Models by the European Commission & on MARKAL models at Brookhaven National Laboratory in the US & elsewhere, has also established that this process of utilizing renewable electricity is likely to result in an inflation protected basis for such capital, interest or securities.

### FIELD OF THE INVENTION

This invention relates to a process for utilizing renewable electricity to define currency amounts in absolute terms.

### BACKGROUND ART

The work on MARKAL models at Brookhaven National Laboratory in the US & elsewhere has established the economic equivalence in developed economies of money and energy, particularly energy in the form of electricity. This rests firmly on the Second Law of Thermodynamics, which places an engineering limit on the efficiency of any industrial process based on the minimum possible increases in entropy in the process. In the MARKAL model the dual solution for any energy cost minimization or profit maximization model is always a money model giving the equivalence statement in money terms of any energy demand, energy resource availability, production process or capacity constraint. This means that any final demand can be defined in terms of its need for people, capital and entropy increases & in a developed society moving towards perpetual sustainability, the entropy increase limit is the most restrictive. It also means that an absolute currency or inflation proofed amount of capital, interest or of a financial security can be defined in terms of electricity, the lowest entropy type of energy.

### DISCLOSURE OF INVENTION

According to the present invention a certified amount of renewable electricity delivered at any suitable defined voltage & at any suitable accessible electricity grid point is utilized as a fully fungible alternative in a currency to a capital amount, or to interest on capital, or to both a capital amount & interest, or to a security, in that currency, thereby defining that currency as an absolute sustainable currency based on the Laws of Thermodynamics, instead of a fiat currency capable of being devalued at will by its issuer. To meet sustainability constraints the electricity used would have to be from an established & certifiable renewable source.

Despite a wide variety of sources & uses for renewable electricity, such a utilization process has not been identified in the patent, scientific or engineering literature to date. Such a process utilizing renewable electricity could be used as a means to raise capital which could in turn be used to develop further renewable electricity resources. Such an amount of renewable electricity could also form an inflation-protected capital amount or financial security as the fiat money counterparty amount is defined such that either the capital amount or interest on capital or both are defined, both in ordinary fiat money terms, such as the pound, the US dollar or the euro, but would also be fully exchangeable at the option of the investor with a certifiable amount of renewable electricity, delivered at a defined voltage at an accessible electricity grid point, this forming an absolute non-fiat currency.

### MODES OF CARRYING OUT THE INVENTION

The modes for carrying out the invention are best accomplished by persons with established renewable electricity resources. Such persons could use their existing renewable resources as a means to raise funds. These funds could in turn be used to develop further renewable electricity resources thereby facilitating sustainable economic development. Such persons could issue bonds resting on a specific amount & voltage of renewable electricity. The renewable origin, potential assignation of title to the capital owner or security holder could be certified by competent certifiers. Such a bond should be saleable at a lower interest rate & therefore a higher price than bonds not having such characteristics. They should therefore more easily facilitate development of further renewable electricity sources, leading to stable economic development based on sustainable resources & the minimum increase in entropy.

An initial set aside of renewable electricity to support such a utilization process thereon could come most conveniently from a set aside of a % of the output of any long established renewable electricity source. Taking Ard-na-Crusha in the Republic of Ireland as an example of one of the longest established & most reliable existing sources of renewable electricity, 12.5% of its output would provide 10 MW of renewable capacity or 87000 MW hours per annum of output. Expressed in $ money terms at $50 per MW hour this comes to an annual money equivalent of $4.35 million. At an interest rate of 2.5% per annum this would correspond to a capital amount of $174 million or $1.4 billion if 100% of Ard-na-Crusha output was used in this way. This would not reduce the capacity of the owner of Ard-na-Crusha to raise funds using any fiat money. It would have the effect of reducing the interest rate paid by the owner of Ard-na-Crusha's output when raising funds utilizing this process. Where demand exists for such absolute financial instruments, it is economically more efficient & transparent to raise funds in this way, rather than in a way that mixes the non-fiat money capacity of renewable electricity into a wider investment pool that does not explicitly reflect the non-fiat money economic advantages of utilizing renewable electricity in this way.

What is claimed is:

1. A process utilizing a certified amount of renewable electricity delivered at a defined voltage & at an accessible electricity grid point as a fully fungible alternative in a currency to a capital amount, or to interest on capital, or to both a capital amount & interest, or to a security, in that currency, thereby defining that currency as an absolute sustainable currency based on the Laws of Thermodynamics, instead of a fiat currency capable of being devalued at will by its issuer.

2. A certified amount of renewable electricity delivered at a defined voltage & at an accessible electricity grid point whenever utilized according to claim 1.

3. A capital amount, financial security or interest on either whenever issued according to claim 1.
